(19) United States
(12) Patent Application Publication
(10) Pub. No.: US 2013/0086504 A1
(43) Pub. Date: Apr. 4, 2013

(54) SYSTEMS AND METHODS FOR FACILITATING NAVIGATION IN A VIRTUAL INPUT DEVICE

(71) Applicants: Girish Venkateswaran, Chennai (IN); Narayan Balasubramanian, Chennai (IN); Beulah Malarvathani, Chennai (IN); Haripriya Raghavan, West Chennai (IN); Poornima Balakrishnan, Chennai (IN); Sasidharan Subramanian, Perundurai (IN)

(72) Inventors: Girish Venkateswaran, Chennai (IN); Narayan Balasubramanian, Chennai (IN); Beulah Malarvathani, Chennai (IN); Haripriya Raghavan, West Chennai (IN); Poornima Balakrishnan, Chennai (IN); Sasidharan Subramanian, Perundurai (IN)

(73) Assignee: Infosys Limited, Bangalore (IN)

(21) Appl. No.: 13/601,770

(22) Filed: Aug. 31, 2012

(30) Foreign Application Priority Data
Sep. 29, 2011 (IN) 3381/CHE/2011

(51) Int. Cl. G06F 3/048

(52) U.S. Cl. 715/773

(57) ABSTRACT

Methods and systems for facilitation navigation through a virtual input device include loading an instance of a virtual input device in response to a user input, filtering the one or more characters populated in one or more cells of the virtual input device instance on the basis of a first predefined policy stored on a processor readable storage medium, receiving a user character input to the virtual input device instance through a user input interface paired with the one or more computing devices, acquiring a set of priority characters related to the user input character on the basis of a second predefined policy stored on the storage medium and populating the virtual input device instance in response to the user character input with the set of priority characters.

### FIELD

The technology relates generally to facilitating navigation through an interface of a virtual input device. In particular, the technology relates to facilitating navigation through a virtual keyboard interface presented on a screen by a remote control device, such as a remote control device for a television, or a set top box.

### BACKGROUND

Increasingly, in a technology area like the consumer electronics space, products that drive the market, including televisions and so on, are associated with a variety of accessories that seek to enhance or simplify the consumer's experience with the primary product. A large range of these accessories may be non-technological, such as cases, screen guards and so on. A similarly large range may be counted as technological innovations on their own, but remain, nevertheless, tied to the primary product. Given these links, then, it is clear that advancement in technologies associated with the primary product driver has a significant impact on the ecosystem of accessories with which the product is associated.

Referring specifically now to the example of Television sets, various iterations of Televisions are equipped with a basic remote control device that incorporate limited functionality, like a channel change control, or volume adjustment. Current trends in the consumer market emphasize interactivity, however. The television, in combination with a set-top-box (STB), now provides a wide range of interactive content in the form of applications, or on-demand content, that are delivered through an internet connection, or by a cable service provider, depending on the capability of the STB. In many cases, full featured usage of this value added content requires the use of a fully functional keyboard, which most contemporary remote control devices fall far short of being.

One solution to this problem would be to change the hardware unit. However, such an initiative would be very resource inefficient, in addition to presenting severe logistical challenges in distribution. A second solution, then, is to display a virtual keyboard on the TV when needed. This solution has been overwhelmingly embraced by device providers, as it circumvents the problems inherent in hardware replacement, while, for the most part, preserving a user's ability to explore value added content.

Significant drawbacks exist with respect to virtual keyboard displays, however, and these largely originate from the requirement to preserve compatibility with legacy remote control devices. For instance, when the keyboard is displayed, navigating from one end of the keyboard to the other is challenging for a user when all she has access to are arrow keys on the remote control device. Additional complexities include a need to program in non-English language support in the keyboard instance. This activity incurs significant cost as it adds complexity to an embedded virtual keyboard implementation by forcing compatibility with diverse Unicode sets.

Accordingly, there is a need for a virtual input device mechanism that can provide a simple and effective means of navigation through a virtual input interface, while retaining all the benefits of a conventional, fully featured, QWERTY style virtual keyboard layout. There is an additional need for any such input device to effectively provide support for disparate character sets, without a substantial increase in complexity in its implementation.

### SUMMARY

The present invention is described by a method executed by one or more computing devices for facilitating navigation across a virtual input device. Aspects of the implementation disclosed include loading an instance of a virtual input device in response to a user input, wherein the instance of the virtual input device comprises a grid consisting of one or more cells, filtering the one or more characters populated in the one or more cells of the virtual input device instance on the basis of a first predefined policy stored on a storage medium associated with the one or more computing devices, receiving a user character input to the virtual input device instance through a user input interface paired with the computing device, acquiring a set of priority characters related to the user input character on the basis of a second predefined policy stored on a storage medium associated with the one or more computing devices, and populating the virtual input device instance in response to the user character input with the set of priority characters.

In an additional embodiment, a system for facilitating navigation across a virtual input device is described, the system comprising at least one computing unit, the computing unit including an input and an output interface and a processor in operable communication with a processor readable storage medium containing one or more programming instructions whereby the processor is configured to load an instance of a virtual input device in response to a user input, wherein the instance of the virtual input device comprises a grid consisting of one or more cells. As disclosed, the system is additionally configured to filter the one or more characters populated in the one or more cells of the virtual input device instance on the basis of a first predefined policy stored on a storage medium associated with the one or more computing devices and receive a user character input to the virtual input device instance through a user input interface paired with the computing device.

### DRAWINGS

These and other features, aspects, and advantages of the present invention will be better understood when the following detailed description is read with reference to the accompanying drawings in which like characters represent like parts throughout the drawings, wherein:

FIG. 1 is an illustrative diagram of a system environment in which the invention is implemented, in accordance with an embodiment.

FIG. 2 is an illustrative diagram of a computing environment in the system environment in which an embodiment of the invention is implemented.

FIG. 3 is an illustrative flow diagram depicting a method of facilitating navigation through a virtual input device, in accordance with an embodiment of the invention.

FIG. 4 is an illustrative diagram of a virtual input device in accordance with an embodiment of the invention, wherein a central position in the grid is highlighted.

FIG. 5 is an illustrative diagram of a virtual input device in accordance with an embodiment of the invention, wherein a character in a non-central position is highlighted for input, and prior to the application of a predefined policy.

FIG. 6 is an illustrative diagram of a virtual input device in accordance with an embodiment of the invention, wherein the characters in non-central positions are displayed in accordance with the application of a predefined policy.

While systems and methods are described herein by way of example and embodiments, those skilled in the art recognize that systems and methods for facilitating navigation in a virtual input device are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include”, “including”, and “includes” mean including, but not limited to.

### DETAILED DESCRIPTION

The following description is the full and informative description of the best method and system presently contemplated for carrying out the present invention which is known to the inventors at the time of filing the patent application.

Embodiments of the present invention include systems and methods for facilitating navigation through a virtual input device.

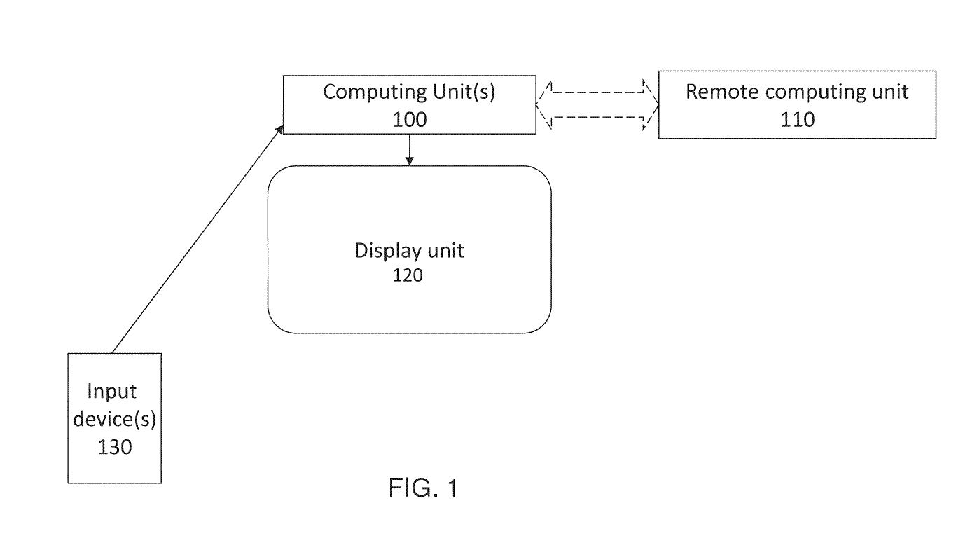

Referring now to FIG. 1, a system environment in which an example embodiment is implemented is shown. The system environment comprises a computing unit 100 in communication with a remote computing unit 110. The computing unit 100 is in further operable communication with a display unit, 120. The computing unit receives input from an input device, 130. The input device 130 may be in communication with the computing unit 100 wirelessly. In an example embodiment, the computing unit 100 may be a set-top box (STB) in operable communication with a display unit, such as, for example, a liquid crystal display (LCD) or cathode ray tube (CRT) television, or monitor. In the embodiment described, the input device 130 may be a remote control device possessing an infrared frequency transmitter capable of transmitting an infrared signal. The STB may further be in communication with a remote computing device, such as a remote server, or a back-end computing device, by means of a wired or wireless communications link with the remote computing device.

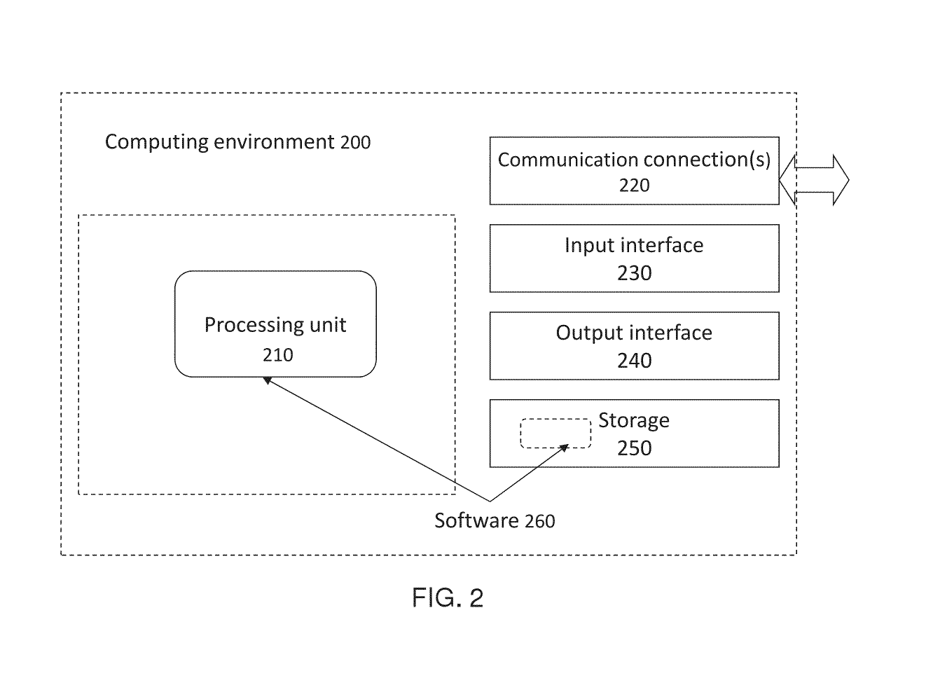

The computing environment, such as an STB, is further described with reference to FIG. 2. As in FIG. 2, the computing environment 200 contains a processing unit 210, including a general or specific purpose processor, a communications connection 220, an input interface 230, such as, in an embodiment, an infrared sensor programmed to detect an infrared signal transmitted by a remote control device. The computing environment 200 additional contains output interface 240, including one or more audio and video output ports, and a processor readable storage medium 250, such as a semiconductor memory module, in operable communication with the processing unit 210. The computing environment runs a software 260, the software 260 stored on the computer readable storage medium, and consisting of one or more programming instructions stored in the processor readable storage medium, the programming instructions suitable for facilitating navigation in a virtual input device.

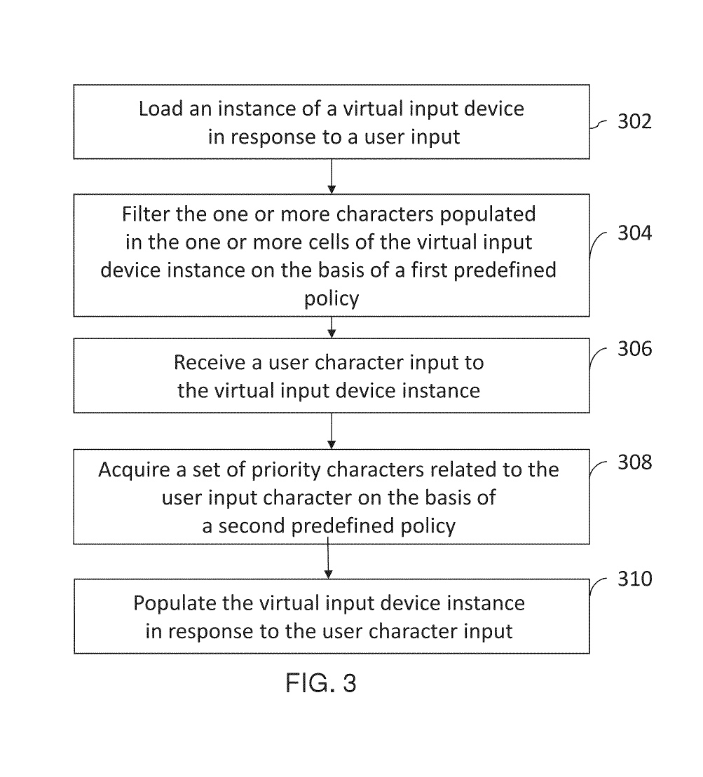

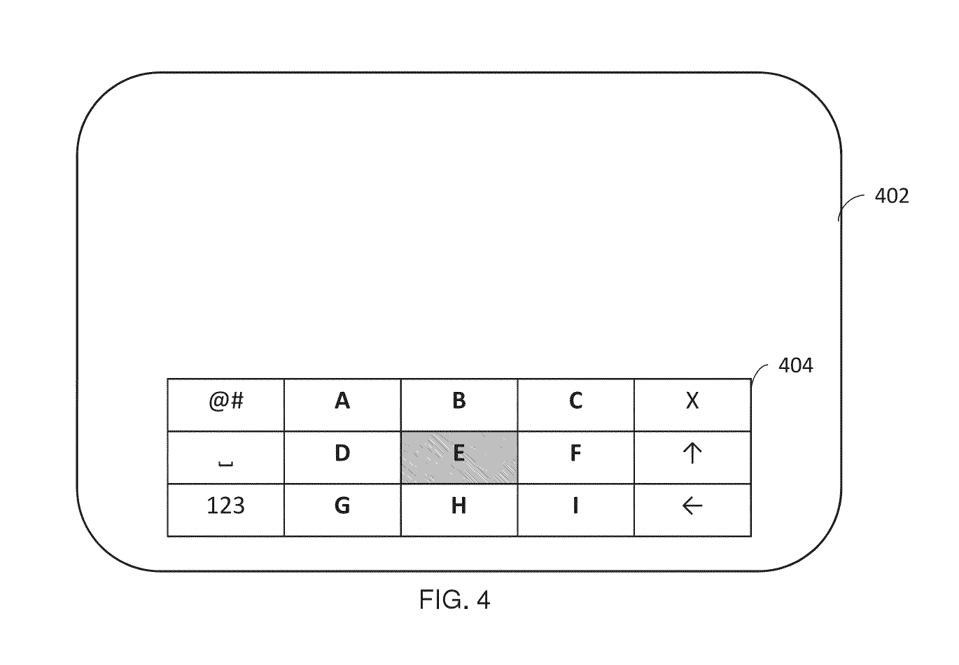

An implementation is further described with reference to FIG. 3. As disclosed, in a first step, 302, an instance of a virtual input device, such as, in a preferred embodiment, a virtual keyboard, is loaded in response to a user input. The user input may include navigation by a user to a text field or text box by means of directional input keys present on the associated remote control device. The virtual keyboard instance may be presented as a rectangular grid containing at least three rows and three columns in the output display device, and each cell in the grid may be populated with an alphanumeric character. In some embodiments, the virtual keyboard instance may be arranged as a 9 cell, or 3×3, matrix of buttons in the center of the keyboard, and 3 buttons vertically aligned along each side. It may alternatively be arranged as a 5×3 or 5×4 input matrix, where 5 indicates the number of rows and 4 the number of columns, as in the example implementation depicted by FIG. 4. In some embodiments, since characters are represented in a matrix, no additional programming is required to add or to delete buttons in the keyboard instance.

In some embodiments, the virtual keyboard instance may issue a request for location identification to the back end computing device, and load a location specific set of characters in the displayed keyboard instance. In a further embodiment, the virtual keyboard instance may issue a request for the alphanumeric character set to be populated in the instance to the back-end computing device whereupon the back end computing device may respond with a location specific character set. The location specific character set may comprise any set of characters that belong to a single language, or may be a multi lingual set of characters.

In a further step, 304, of FIG. 3, one or more characters populated in the one or more cells of the virtual input device instance are filtered on the basis of a first predefined policy. In a preferred embodiment, the predefined policy may be defined in the back-end computing device. The predefined policy selected may filter characters on the basis of an input condition. For example, if a virtual keyboard instance is loaded in response to a call by a user interface component, such as by a text field, and the text field is restricted to numeric characters, a filtering policy that is applied to the virtual keyboard instance removes all alphabetic characters populated in that virtual instance. Filters are generally programmable, and help in validations in the keyboard level. In an additional example, when only characters from A to E and numbers are to be input into a hexadecimal text field, a filtering policy that defines said range of input may be defined and linked with the virtual keyboard instance by means of the back-end computing device, or a linked remote computing device. Consequently, only the sets of inputs desired are fed in to the keyboard instance and no other characters may be displayed in the output display device.

In a further step, 306, a user input, such as a character input or a numeric input may be received by the virtual input device instance. User input may, as in a preferred embodiment, be received from a remote control device in wireless communication with the computing device wherein the virtual keyboard instance is executed. To facilitate input, as in a preferred embodiment, the input interface presented in the display device by the virtual keyboard instance includes a point of focus, as in the example embodiment 404, in FIG. 4. As shown, the point of focus always remains in the center of the keyboard. A benefit associated therewith is that only two clicks, or button presses, are required for a user to navigate between any of the displayed set of keys at any point of time.

On receiving the user character input, the complete word or set of characters input by the user by means of the input interface are analyzed. This is further explicated in a step, 308, wherein the virtual input device instance acquires a set of priority characters related to the user input character on the basis of a second predefined policy. In some embodiments, in order to appropriately determine the set of priority characters acquired, the virtual keyboard instance may send the user input character set to the back-end computing device, or remote computing device. The input character is then identified and an appropriate set of priority characters to be applied is determined on the basis of rules defined in a second predefined policy. The second predefined policy may be a desired business algorithm wherein the algorithm is configured to recognize an input character, and associate the input character with a set of characters. The character set associated with the input character is the priority set for that input character. One or more rules that control the association may be predefined in the back-end computing device.

In a further step, 310, the virtual input device instance is populated in response to the user character input. Consequently, in combination with 308, the virtual keyboard instance dynamically checks if a policy is applicable to a given character input, applies the policy and refreshes the keyboard instance with a set of priority characters acquired on the basis of the policy.

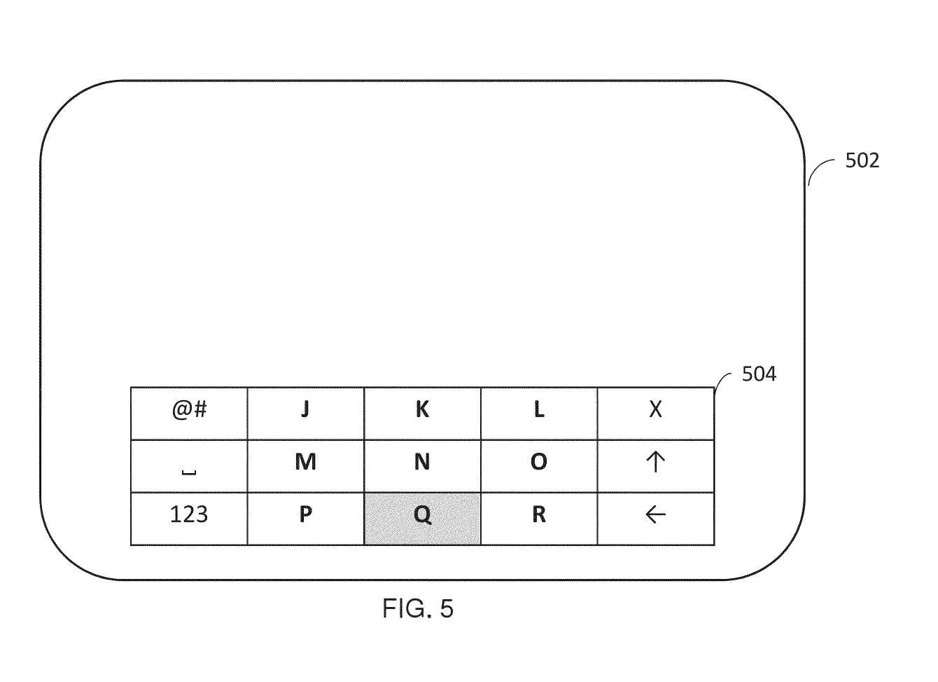

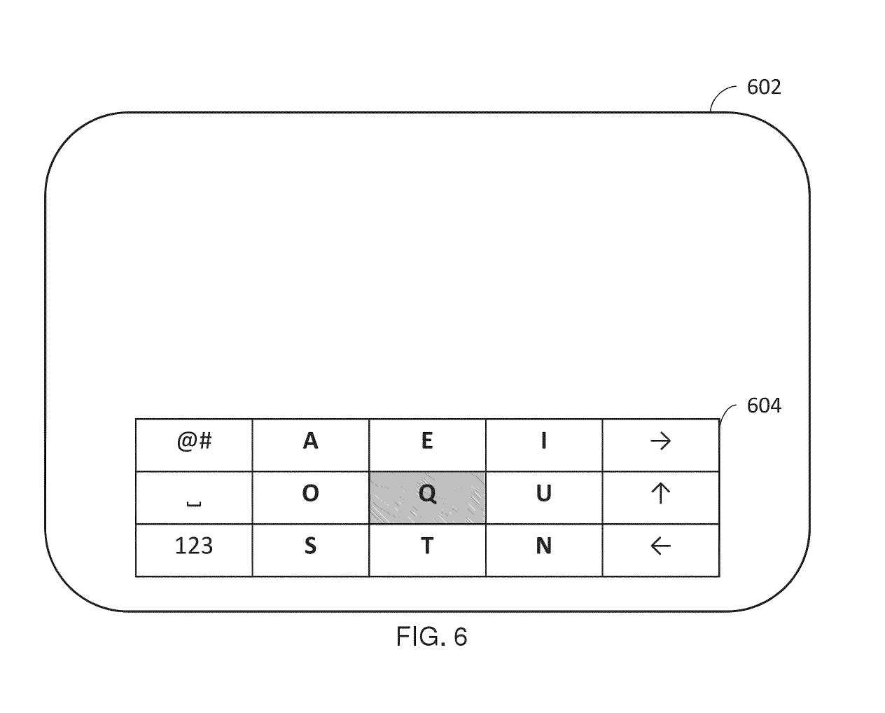

An example embodiment whereby an instance of this mechanism is applied is illustrated in FIGS. 5 and 6. In FIG. 5, the virtual keyboard instance 504 is displayed in an output display device 502. A character ‘Q’ is highlighted in 504, signifying that the character ‘Q’, then, is input by the user through the virtual keyboard interface. On receiving the input character ‘Q’, the virtual keyboard instance may check if a policy is associated with the input character ‘Q’ by communicating with the back-end computing device. In the example described, a priority set of characters associated with ‘Q’ may include a set of letters of the English alphabet that are statistically the most common letters used in combination with the character ‘Q’. The virtual keyboard instance 504 is then refreshed with the priority set of characters, as depicted in FIG. 6 wherein the refreshed instance 604 is displayed in the output display device 602.

In an additional embodiment, when a ‘page up’ or ‘page down’ character is input, the virtual keyboard instance is refreshed in accordance with a predefined policy. In additional embodiments, the characters populated in the virtual keyboard instance may include alphabets, or symbols, or numbers, or pictures and policies defined whereby filters are applied to the set of characters, or numbers, or pictures, or symbols in accordance with the one or more embodiments previously described.

Benefits associated with the one or more described embodiments include enabling a user watching a television to type into any interactive application. The embodiments described provide seamless integration for cable content service providers to incorporate multi-lingual features, and for an application developer to implement filters in a set of characters, numbers, symbols or pictures. TV remotes originally meant to change channels, volume, or provide primitive menu navigation can be converted into usable implements for interaction with complex applications that require a full range of alphanumeric input by means of the embodiments disclosed.

The present description includes the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiments shown but is to be accorded the widest scope consistent with the principles and features described herein.

As will be appreciated by those ordinary skilled in the art, the aforementioned example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code.

What is claimed is:

1. A method executed by one or more computing devices for facilitating navigation across a virtual input device, the method comprising:
loading an instance of a virtual input device in response to a user input, wherein the instance of the virtual input device comprises a grid consisting of one or more cells and each of the one or more cells are populated with one or more characters;
filtering the one or more characters populated in the one or more cells of the virtual input device instance on the basis of a first predefined policy stored on a storage medium associated with the one or more computing devices;
receiving a user character input to the virtual input device instance through a user input interface paired with the one or more computing devices;
acquiring a set of priority characters related to the user input character on the basis of a second predefined policy stored on a storage medium associated with the one or more computing devices; and
populating the virtual input device instance in response to the user character input with the set of priority characters.

2. The method as claimed in claim 1, the method further comprising:
requesting one or more sets of characters to be filtered out for the instance of the virtual input device from a remote computing device that stores at least one predefined filtration policy.

3. The method as claimed in claim 1, further comprising:
requesting characters specific to a user's locale, including a language specific set of characters;
receiving characters specific to the user's locale from the associated storage medium; and
populating the virtual input device instance with the requested characters.

4. The method as claimed in claim 1, further comprising unloading the virtual input device instance in response to a user request.

5. The method as claimed in claim 1, wherein filtering includes displaying the filtered set of characters in an output display device.

6. The method as claimed in claim 1, wherein the second predefined policy includes the association of a vowel character in the English language with a consonant character in the English language.

7. The method of claim 1, wherein populating comprises populating the virtual input device instance with one or more applicable characters from the set of priority characters acquired.

8. The method as claimed in claim 1, further comprising displaying the populated virtual input device instance on an output display device.

9. The method as claimed in claim 1, wherein the grid consists of three horizontal rows and three vertical columns and each row and column consists of three cells.

10. The method as claimed in claim 6, further comprising visually highlighting a position in the grid associated with a display of the virtual input device instance in an output display device, the position indicative of a navigational position in the virtual input device.

11. The method as claimed in claim 10, wherein the geometric center position of the grid is visually highlighted in the virtual input device instance when the virtual input device instance is displayed in an output device.

12. The method as claimed in claim 11, wherein a visual highlight indicator linked with a current user navigational position returns to the geometric center of the grid following a user input through an associated user input device.

13. A system for facilitating navigation across a virtual input device, the system comprising:
at least one computing unit, the computing unit including an input and an output interface and a processor in operable communication with a processor readable storage medium containing one or more programming instructions whereby the processor is configured to:
load an instance of a virtual input device in response to a user input, wherein the instance of the virtual input device comprises a grid consisting of one or more cells;
filter one or more characters populated in the one or more cells of the virtual input device instance on the basis of a first predefined policy stored on a storage medium associated with the one or more computing devices; and
receive a user character input to the virtual input device instance through a user input interface paired with the computing device.

14. The system as claimed in claim 13, wherein the processor is further configured to:
acquire a set of priority characters related to the user input character on the basis of a second predefined policy stored on a storage medium associated with the one or more computing devices; and
populate the virtual input device instance in response to the user character input with the set of priority characters.

15. The system as claimed in claim 13, wherein the processor is further configured to:
request one or more sets of characters to be filtered out for the instance of the virtual input device from a remote computing device that stores at least one predefined filtration policy.

16. The system as claimed in claim 13, wherein the processor is further configured to:
request characters specific to a user's locale, including a language specific set of characters;
receive characters specific to the user's locale from the associated storage medium; and
populate the virtual input device instance with the requested characters.

17. The system as claimed in claim 13, wherein the processor is further configured to unload the virtual input device instance in response to a user request.

18. The system as claimed in claim 13, wherein the processor is further configured to filter includes displaying the filtered set of characters in an output display device.

19. The system as claimed in claim 13, wherein the second predefined policy includes the association of a vowel character in the English language with a consonant character in the English language.

20. The system of claim 13, wherein populating comprises populating the virtual input device instance with one or more applicable characters from the set of priority characters acquired.

21. The system as claimed in claim 13, wherein the processor is further configured to display the populated virtual input device instance on an output display device.

22. The system as claimed in claim 13, wherein the grid consists of three horizontal rows and three vertical columns and each row and column consists of three cells.

23. The system as claimed in claim 22, further configured to visually highlight a position in the grid associated with a display of the virtual input device instance in an output display device, the position indicative of a navigational position in the virtual input device.

24. The system as claimed in claim 23, wherein the geometric center position of the grid is visually highlighted in the virtual input device instance when the virtual input device instance is displayed in an output device.

25. The system as claimed in claim 24, wherein a visual highlight indicator linked with a current user navigational position returns to the geometric center of the grid following a user input through an associated user input device.

26. Computer-readable code stored on a non-transitory computer-readable medium that, when executed by a computing device, performs a method for monitoring and controlling a service level agreement, the method comprising, the method comprising:
filtering the one or more characters populated in the one or more cells of the virtual input device instance on the basis of a first predefined policy stored on a storage medium associated with the one or more computing devices;
receiving a user character input to the virtual input device instance through a user input interface paired with the one or more computing devices;
acquiring a set of priority characters related to the user input character on the basis of a second predefined policy stored on a storage medium associated with the one or more computing devices; and
populating the virtual input device instance in response to the user character input with the set of priority characters.
